(19) United States
(12) Patent Application Publication
(10) Pub. No.: US 2013/0226699 A1
(43) Pub. Date: Aug. 29, 2013

(54) METHODS AND SYSTEMS FOR IMPROVED CUSTOMER RELATIONSHIP MANAGEMENT

(71) Applicant: SAPHURA SAFAVI LONG, SIGNAL MOUNTAIN, TN (US)

(72) Inventor: SAPHURA SAFAVI LONG, SIGNAL MOUNTAIN, TN (US)

(21) Appl. No.: 13/610,167

(22) Filed: Sep. 11, 2012

Related U.S. Application Data
(60) Provisional application No. 61/603,614, filed on Feb. 27, 2012.

(51) Int. Cl. G06Q 30/00; G06Q 30/02

(52) U.S. Cl. 705/14.53; 705/27.1

(57) ABSTRACT

Disclosed is a comprehensive business-client networking tool designed for any entity with a large consumer base. All customers and employees of the entity may be members of the entity's online community. Each member may have a landing page or “wall” provided online by a secure site, which may present the member's profile, all vendor products owned by the client and a history of any associated services performed by the entity. The customer can communicate via text messaging with the dealership employees that have previously worked with them. Specific messages can be posted on the employee' wall by customers. Customer messages may also be posted on walls of other customer members with common interests, when the entity permits such interactions. These and other disclosed features supplant the need for complex advertisements and campaigning by business entities to their existing consumer base.

### CROSS-REFERENCE TO RELATED APPLICATIONS

This application claims priority under 35 U.S.C. §119 to U.S. Provisional Patent Application Ser. No. 61/603,614 entitled “METHODS AND SYSTEMS FOR IMPROVED CUSTOMER RELATIONSHIP MANAGEMENT” filed in the name of Saphura Safavi Long on Feb. 27, 2012, the entirety of which is hereby incorporated by reference.

### TECHNICAL FIELD OF THE DISCLOSURE

This invention generally relates to electrical computers and digital data processing systems in a network environment, and in particular it relates to customer service and network-based communications between vendors and customers.

### BACKGROUND

The automobile sales market, like many others, has been affected by the massive change brought forth by the Internet over the past two decades. For instance, the Internet has fostered an empowerment of the individual consumer regarding automobile purchases. The availability of information regarding automobile retail price premiums and invoice costs has resulted in additional pressure on dealers' gross margins. Whereas ten years ago automobile dealerships competed on brand appeal in local markets, the Internet now permits consumers to compare prices among dealers in different regional markets. Moreover, consumers currently have the opportunity to be extremely well prepared as they enter negotiations with a typical dealer regarding delivery price.

While the Internet has become a useful tool for automobile purchasers, it is also slowly being adopted by vendors and dealers in a number of areas, including obtaining sales leads and managing customer relations and inventory. In recent years, for example, dealerships have been receiving sales leads using the INTERNET LEAD MANAGEMENT tool. IZMOCRM, RECKONUP, VINSOLUTION and DEALER SOCKET provide dealerships with various combinations of database-driven sales lead, customer relationship management (CRM) and inventory management functions via the Internet. VAUTO, HOMENET and DEALERTRAK also provide dealerships with web-based tools specific to inventory management. Such systems offer many individual advantages but are, in the end, limited in their usefulness and functionality. For example, all these functions that are generally required by dealerships are implemented on many disparate data systems. Shifting from one system to another is time consuming and may entail duplicative database entry. Training on all these systems is often costly and it is typically difficult to deliver and properly track messages to and from customers.

Dealerships are also grappling with how to best communicate with their potential and current customer base, particularly since recent market surveys have shown that one of the most aggravating issues consumers cite is the ability to efficiently contact their servicers. Most respondents indicate that finding and communicating with the right person within the company who can address their concern easily and in a timely manner is the number one communication issue. One existing communication option is direct mail, but this is an expensive and outdated method with limited responsiveness in today's marketplace. Dealers generally maintain a web site that provides some limited ability to communicate to clients via the Internet. All these tools come with separate needs, costs and requirements and entail having separate servicers with contracts and recurring charges.

Among the populace, the popularity of social networks, such as FACEBOOK, LINKEDIN and MYSPACE, has been growing exponentially in recent years. These existing social networks are free tools where anyone can become a member. The user can put whatever information they like on these sites and make it open to all users or only their designated “friends.” The ability to communicate with others is the primary drive for membership in these online environments. Accordingly, it would be useful if dealerships and other vendors could harness the popularity of social networking to improve their customer relations.

However, vendors and dealers have a unique set of needs that simply cannot be satisfied using conventional social networks. Such sites are far more socially oriented rather than business oriented. In fact, most social network users feel that social networks are primarily for communicating with friends and business intrusions in these realms are typically quite unwelcome. There is no ability for the vendor to monitor or control public content posted by other members. They also do not come with built-in tools or functionality that are readily adaptable by vendors and dealers for their customer relations needs.

Accordingly, there is a need for methods and systems for improved customer relationship management that addresses certain problems and deficiencies in existing technologies.

### SUMMARY

It is an object of the present disclosure, therefore, to introduce an improved online customer relations system, which includes a vendor-centric network environment that is equally useful for vendors, such as automobile dealers, their employees, and their existing and potential customers alike.

In particular, one aspect of the invention includes a method, performed exclusively over a computer network by a system including at least one special purpose computer of a vendor. A data communication interface having a network address on the computer network is established for communicating data with the at least one special purpose computer of the vendor, for example, over the Internet. The data communication interface allows communication devices of a plurality of actual or potential customers of the vendor to transmit data to and receive data from the at least one special purpose computer of the vendor. A data connection is established between a transaction database of the vendor and the at least one special purpose computer of the vendor, for accessing stored transaction data of purchase transactions between the vendor and the plurality of customers. The stored transaction data includes, inter alia, an indication of those employees of the vendor that have been involved with existing transactions between the vendor and the plurality of customers. A data template is established for presenting data from the at least one special purpose computer of the vendor on displays of the communication devices of the plurality of customers. The data communication interface may receive an electronic request from a communication device of a customer to access the at least one special purpose computer of the vendor. The electronic request includes an identification of the customer. In response to the electronic request, existing purchase transactions between the customer and the vendor are identified from the transaction database, including an identification of those employees of the vendor involved with the existing purchase transactions. A customer-specific data template is then transmitted over the computer network for display on the communications device of the customer.

In various embodiments of the disclosure, the customer-specific data template may include selectable options for communicating with only those employees of the vendor involved with the existing purchase transactions of the customer. The customer-specific data template may also include an advertisement of a third party advertiser from the plurality of advertisements, the advertisement selected based on a geographic location of the customer and the existing purchase transactions between the customer and the vendor. The customer-specific data template may likewise include a customer-specific profile page having information about the customer that is selected exclusively by the vendor.

The vendor-centric network environment, sometimes referred to herein as GRATIS TOOLS, will provide a method for vendors to file and store information about customer's purchased products on the Internet or a cloud environment, which is accessible by customer as well as the dealership personnel. The GRATIS TOOLS environment will allow the customer to communicate with vendor employees, view transaction histories and service schedules, setting appointments and seeing the best offers available, all on one site without ever having to maneuver to other locations on the Internet.

### BRIEF DESCRIPTION OF THE DRAWINGS

Further aspects of the present disclosure will be more readily appreciated upon review of the detailed description of its various embodiments, described below, when taken in conjunction with the accompanying drawings, of which:

FIG. 1 is a schematic diagram of an exemplary vendor-centric network environment according to the present disclosure;

FIG. 2 is an exemplary display of a vendor server interacting with the network environment of FIG. 1;

FIG. 3 is an exemplary display of a customer terminal interacting with the network environment of FIG. 1;

FIG. 4 is a flowchart depicting an exemplary process performed by a vendor computer participating in the network environment of FIG. 1;

FIG. 5 is a flowchart depicting an exemplary process performed by a customer device participating in the network environment of FIG. 1; and

FIG. 6-9 are exemplary algorithms and program listings for accomplishing various functions of a vendor-centric network environment according to the present disclosure.

### DETAILED DESCRIPTION

In order to readily facilitate customer relations and communications, the vendor-centric network environment disclosed herein, sometimes referred to as GRATIS TOOLS, will provide customer and inventory management software tools in a manner that will be readily familiar and comfortable for users of prior social networks. These tools will be primarily described with respect to the automobile industry herein. However, it should readily appreciated by a skilled artisan that the usage of these tools will not be limited to that industry alone, and can be readily adapted to a wide variety of other markets, including any entities with significant number of clients and multiple employees.

In various embodiments, the vendor-centric network environment may be provided online as a cloud service that accommodates many different vendors in differing geographical regions simultaneously. Each vendor will have their own subset of distinct customers and employees in a self-contained virtual network environment. All employees of the vendor, all prospects and all customers who have had any transactions with a vendor are members of that vendor's network. GRATIS TOOLS allows all of a given vendor's employees and customers to directly interact via various vendor-controlled functions exclusively within that vendor's network environment. For employees of a given vendor, the network will provide various customer relationship management, inventory management and sales tools. Employees may also be enabled to communicate with existing or potential customers in a variety of manners. Customers may use GRATIS TOOLS to communicate with employees of a vendor, view their own detailed transaction history online, and add information to their system-generated customer profile on their own secure “wall.” Widgets with certain defined functionality will be provided to customers along with their wall and transaction history. Customers may also establish wish lists of products and services via their wall. Vendors will be able to directly view customer interactions with the vendor-centric network environment and gain valuable insights as to customer behavior and desires. Vendors will be able to leverage this information to enable targeted third-party advertising to customers with proven purchasing and participation. The foregoing functions available to customers, employees and vendors will be described in more detail herein below.

By subscribing to GRATIS TOOLS, vendors will no longer need to establish, maintain and update a separate, static web site of their own. The wall functionality available to customers will allow the vendor to target specific promotions and offers to the customer with ease. GRATIS TOOLS will enable vendors to allow easy access to their customers for direct employee communication, available product inventory and review of their historical transactions in detail. For example, a customer may simply post a textual message on the wall of the vendor or an employee. The vendor or an employee may post a specific textual message of the wall of a customer, after which the customer may be automatically notified via a cellular text message, electronic mail (e-mail), voicemail or other outside notification that a message is awaiting them on their wall. Messages could be posted by vendors/employees simultaneously to customers with common profile characteristics, replacing the need for complex market campaigning.

GRATIS TOOLS shares certain features found in prior social networks, such as FACEBOOK or MYSPACE. For example, customers in prior social network environments may establish and manage all aspects of their virtual profiles, referenced herein as a wall, where certain information may be shared with other community members. In addition, direct communications with other network participants, such as by e-mail, text message, wall posting, voice chat, audio-visual message and video conferencing, are readily provided in prior technologies.

However, there are several important physical and technological features found in GRATIS TOOLS that are not found in prior technologies. For example, unlike the profiles of most familiar social networking tools that provide the ability to create and manage their personal profile, the wall introduced herein is more about the customer's product profile, based on purchases and transaction made with the vendor. Also, unlike all preceding social network environments, it is the vendor, as opposed to the customer or owner-operator of the vendor-centric network, who solely determines privileges and options available to customers and employees of that vendor. In various embodiments, customer and employee “profiles” are only visible by those with rights and privileges to see it as established by the vendor and generated exclusively by the vendor through the GRATIS TOOLS system. Accordingly, no customer necessarily has the ability to create their own profile or access the profile of another. All employees may be restricted to accessing the walls of those customers to whom they are assigned or have physically interacted. Higher level employees of the vendor maybe be able to access all profiles in the network environment. Total access to views of the vendor's current inventory is nevertheless available to all members of the vendor's network in order to maximize the potential for sales.

While a wealth of tools and communications can be provided at the vendor's sole discretion, the customers in particular may not have full ability, for example, to post disparaging or unjustifiable comments to other customers. Customers are however free to share various types of other information with others, such as products previously purchased or products on the customer's wish list. This ability gives vendors unprecedented capability to police its network environment effortlessly, and therefore provides significant technological and practical advantages over current social networking functions.

The customer may also communicate via text messaging with the vendor's employees assigned to him or those involved in previous face-to-face dealings between the customer and the vendor. Specific messages may also be posted on the wall of the vendor by customers, and particularly, on the walls of specific employees that have previously transacted with the customer.

With respect to vendors that are automobile dealers in particular, most dealerships in the US have some sort of customer relationship management (CRM) software in place and have developed the understanding of that need for effective marketing and customer retention. They also predominantly use a Dealer Management System (DMS) along with either an Original Equipment Manufacturer (OEM) compliant web site or an in-house developed website for communicating with the marketplace. Dealerships have largely come to realize that bombarding client with direct postal mail or electronic mail (e-mail) is losing its traditional effectiveness, and that such communications in existing social networking environments are only successful if they are first “liked” or otherwise accepted by individual consumers. However, there is also a wide variance in the technical sophistication and abilities of dealerships. Consequently, many dealerships have gotten weary of employing separate software tools for CRM and DMS, which typically entail long-term contracts and complex usage characteristics. Although there are many free software tools in the market place, there has been nothing that brings together CRM, DMS and networking functions in one single tool.

In order to maximize appeal and uptake, GRATIS TOOLS introduced herein may integrate with the leading existing DMS and CRM products to insure the most up-to-date and accurate information and facilitate data migration for those vendors that would like to switch to the Gratis environment. GRATIS TOOLS will also be able to provide OEM generated leads that are generally provided over the World Wide Web in existing technologies. Other services will include marketing capability for “wall” or web site development, if the vendor wishes to subscribe to these functions. GRATIS TOOLS may also provide other services, such as finance and insurance sales and inventory management tools.

The main function and key value proposition of GRATIS TOOLS is that it assists vendors in managing, retaining and controlling their valuable client base, resulting in measurable increases in sales. The increase in sales is measured not only by new car sales but by increased revenues from the service department, third party advertising and financing products as well. Additionally, GRATIS TOOLS enhances existing DMS systems by creating front-end Business Development Centers for clients, as described further herein.

GRATIS TOOLS is designed to be an easy-to-use software package that allows vendors and dealers to become more proactive in their approach to marketing and sales by allowing them to manage information regarding past, current and prospective customers. Various functions of GRATIS TOOLS include filters to organize the typically extensive customer databases already maintained by vendors, thereby allowing them to readily generate internal management reports and external marketing materials necessary for prompt customer contact and follow up. To that end, GRATIS TOOLS will also interface with existing or legacy database systems used by vendors, to accommodate data migration and the like.

In place of prior stand-alone software offerings, GRATIS TOOLS will also serve as a vendor's sales lead management system. This function is designed specifically for managing customer and contact information to improve the efficiencies of the dealer's sales and service department efforts. GRATIS TOOLS will also readily interface and communicate with all existing OEM sales lead management systems that provide certified lead management tools, to assist in data migration and uptake from existing sales lead systems.

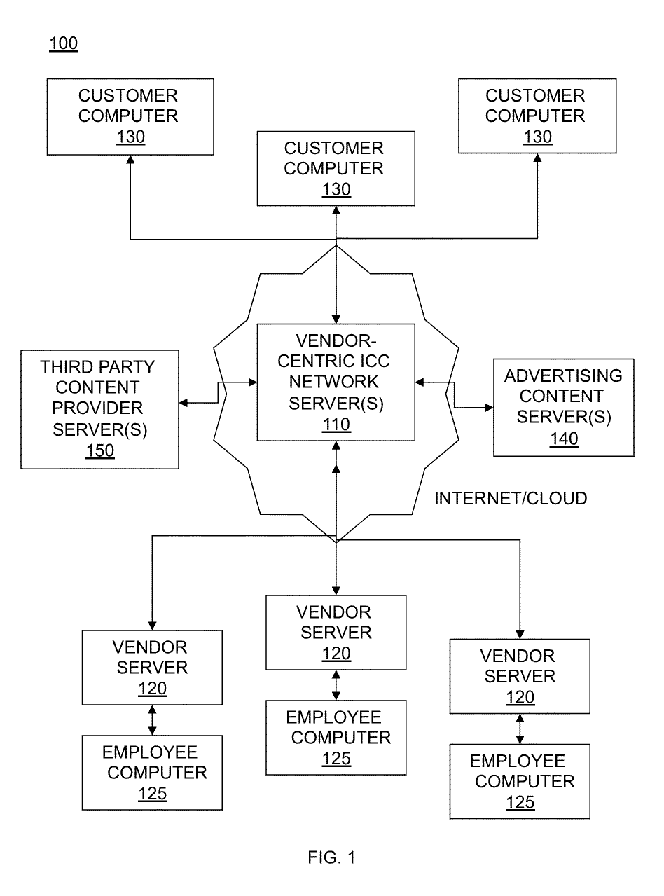

While the general features of GRATIS TOOLS, which provides a vendor-centric network environment, have been outlined generally in the foregoing, the specific technical and implementation details of GRATIS TOOLS will now follow. Referring now to FIGS. 1-9, wherein similar components of the present disclosure are referenced in like manner, various embodiments of a method and system for customer relationship management will now be more particularly described.

Turning to FIG. 1, there is depicted an exemplary Internet-based network environment 100, in which GRATIS TOOLS may be implemented and operative. The vendor-centric interactive customer community (ICC) network servers 110 are the hub of the network environment 100, the special programming of which as described herein enables the vendor, employees and customers to interact as described herein over the Internet. The network server(s) 110 may be one or a group of distributed or centralized network computer servers. Such servers, like any common personal computer, include well-known processors, electronic memory, network communication hardware, user interfaces, input/output devices, operating system software, and application software suitable for accomplishing the functions described herein. A suitable computer server may be one or more enterprise network servers of the type commonly manufactured by CISCO, DELL and IBM. The network server(s) 110 may be configured to perform the functionalities described herein through suitable programming in C++, PHP, JAVASCRIPT or the like, and may include databases and database management software, for example, similar to the SQL type databases distributed by ORACLE. The network server(s) 110 may be centrally located or may be distributed among a variety of geographical locations, and may cooperate to enable to social networking functions described herein. It is contemplated that the network server(s) 110 may be owned and operated by an entity that is distinct from the vendors. Vendors may subscribe to GRATIS TOOLS and its various functionalities via agreements with the owner/operator of the network server(s) 110. The network server(s) 110 may act as a “cloud” service to a plurality of vendors, including hosting software functions and maintaining databases such that vendors do not need to expand their existing computing capabilities in order to employ GRATIS TOOLS.

The network environment 100 includes one or more vendor servers 120. Each vendor server 120 may belong to and be exclusively operated by separate and distinct vendors who subscribe to GRATIS TOOLS. The vendor servers 120 may be any type of computer network server of the type described in the preceding paragraph, that are operative to enable data communications over a computer network, such as the Internet.

Each vendor server may be in operative communication with one or more employee computers 125. The employee computers 125 allow employees of a vendor to interact with the vendor-centric ICC network server(s) 110 via the vendor server(s) 120, or in direct communication when such computers are enabled to communicate directly, via suitable hardware and programming.

Customer computers 130 may be one or more separate consumer computing devices that are operative to communicate data bi-directionally with the network server(s) 110 over a computer network such as the Internet. The customer computers 130 may be owned and operated by separate and distinct customers. Customers may be assigned a login to access the network server(s) 110 and the online community of a vendor, to which they are a member. The customer may, in various embodiments, access the network server(s) 110 via her customer computer 130 without any charge or subscription requirement. When interacting with the network server(s) 110 over the Internet, a display of the customer computers 130 may be changed and updated to enable the customer to directly interact with the network server(s) 110 in the manners described herein.

Each of the employee computers 125 and the customer computers 130 may be any suitable computing or communication device used to accomplish the processes described herein. They may be, for example, a personal computer, laptop computer, notebook computer, mobile telephone, smartphone, tablet, personal digital assistant or like device of the type commonly manufactured by IBM CORP, DELL CORP. and APPLE CORP., and having suitable operating system software (i.e., WINDOWS XP, WINDOWS VISTA, WINDOWS 8, MAC OS X, SUN OS), application software, visual displays, processors, electronic memory, network communication hardware, user interfaces (such as a visible display), and other suitable input/output devices, as are well-known and suitable for accomplishing the functions described herein.

The network environment 100 may also include one or more advertising content server(s) 140 that are established by a third party to deliver advertising content to the network server(s) 110 for presentation on the displays of customer computers 130 when the customer interacts with the network server(s) 110. The third party advertising may be targeted to customers with certain demographics, prior purchasing history or confirmed product preferences, as described further herein. The targeted advertising my likewise be selected for a customer based on geographic location of the customer and the third-party. The advertising content server(s) 140 may be configured as any type of known network server and as heretofore described. For example, a vendor may allow advertising for other vendors services in their locality. The advertisers may be selected by the operator of the network server(s) 110. The revenue from these advertisements will allow dealer to be able to subside their subscription to GRATIS TOOLS or otherwise share in the revenue generated, based on the revenue model employed.

The network environment 100 may also include one or more third-party content provider server(s) 150 that communicate with the network server(s) 110 over a computer network such as the Internet. Third-party content providers may include providers of sales lead data that are accessible by the vendor and its employees via their computing devices. Third party content may also include information provided by the various manufacturers of products sold by a vendor. For example, where the vendor is an automobile dealership, the third party content may be information from manufacturers' databases on makes and models of cars manufactured by a third-party manufacturer and sold by the vendor to its customers. Such third-party content may includes a parts database and notice from the manufacturer to owners of its manufactured products. The third-party content may be accessible by employees of the vendor and its customer via their computing devices described herein above. The third-party content provider server(s) 150 may be configured as any type of known network server and as heretofore described.

In certain embodiments, the network environment 110 is implemented over a publicly-accessible computer network, such as the Internet or World Wide Web. The disclosure is not limited to implementation in any specific network configuration, and is readily contemplated to include the use of any wireless and/or hard-wired devices operating in conjunction with satellite, microwave, fiber optic, copper, local area networks (LANs), wide-are networks (WANs), WIFI, WIMAX and/or other network configurations. It is readily apparent that the network environment 100 may be implemented in any type of system comprising interconnected computers configured to communicate data with each other using messages transmitted electronically or via other means, without limitation.

Data may be transmitted between the computers and servers shown in FIG. 1 using any of the variety of data formats including, but not limited to, Hypertext Transfer Protocol (HTTP), file transfer protocol (FTP), or any of a variety of known data transmission protocols. Data transmissions may also be encrypted with any of a variety of known technologies, including secure socket layer (SSL) topologies.

GRATIS TOOLS is an enterprise-based application, which is capable of supporting multiple users through separate logins to the system. The application may be hosted at a secure web hosting site that is accessed over the web by vendors, their employees and their customers. GRATIS TOOLS is fully scalable and ready to interface and integrate seamlessly with other applications from business partners and vendors and address the needs of other entities with large clientele. This allows GRATIS TOOLS to become a new link in the customer value chain where new features and functionalities including those of the strategic partners are presented to the vendors in a standard, readily useable format.

GRATIS TOOLS is built based on the technology principle known as “software as a service” (SaaS) or as Active Server Pages (ASP) that distribute business software on a subscription basis. As such, vendors and their community members only need an Internet connection to access the service online. All online application services are hosted in secure and robust data centers and are available to users twenty four hours a day and seven days a week.

GRATIS TOOLS may be framed by a flexible, dynamic, and loosely-integrated suite of services that can be used within multiple business domains. This service-oriented architecture (SOA) provides an easy integration with third parties and secures data transactions with various OEMs without affecting its core businesses and functionalities. No application programming interface (API) or other specific requirements are necessary for third parties to integrate with the system. All standard web services may be accommodated by GRATIS TOOLS.

GRATIS TOOLS interface is designed to provide Web experience with not only abundant valuable information but also sharable, interoperable, and user centered information. GRATIS TOOLS fully supports users' participation in the virtual community by complying with all web browsing software, such as INTERNET EXPLORER, FIREFOX, SAFARI, and CHROME, and by complying with common mobile device standards, such as are required by BLACKBERRY or IPHONE devices. GRATIS TOOLS also complies with internationalization and localization functionality known as 118N, so that the functionalities of GRATIS TOOLS may be readily adapted to different languages and regional differences without engineering changes. In summary, GRATIS TOOLS breaks down all common system dependencies and requirements such as system installations, computer operating systems, internet browsers, mobile access devices, languages and regions, such that community members may access or integrate the service with only a simple Internet connection.

In accordance with the foregoing, the hosted software model of GRATIS TOOLS will allow various vendors to rapidly maintain its relationship with existing customers and to acquire new customers, while also providing a very valuable stream of recurring revenue through third party advertising.

Further advantages of GRATIS TOOLS include easy migration of existing vendor data. Vendors, such as automobile dealerships, typically hold large databases of their inventory and customers, including CRM, DMS sales leads and inventory data. These databases may be stored, for example, in the memory storage devices of the vendor servers 120. Such databases hold a veritable gold mine of useful marketing information, which are not generally fully leveraged in today's marketplace. GRATIS TOOLS enables vendors to cross-reference and analyze their existing customers purchasing history to readily accommodate further sales potential, enhance customer communication, thereby enhancing the revenue potential of their existing data.

In addition, many vendors today still operate their internal departments separately. That is, an individual department of a vendor (such as a sales department, or a service department) may send information to a customer that is not communicated to other employees in different departments of the vendor. The customer therefore at times could be totally confused as to the nature of a communication when dealing with separate department. By utilizing interactive customer community (ICC) models, GRATIS TOOLS ensures that all employee communications to a customer are available for other employees of a vendor so that miscommunications and duplicative efforts are avoided. ICC models also work because it is “social”, familiar to customers and employees alike, and fun to use compared with other communication options. By employing GRATIS TOOLS, vendors automatically increase their ability to communicate with customers and between various departments.

FIG. 1 shows the simplicity of GRATIS TOOLS's network environment 100, which provides several additional advantages. Namely, there is now provided a sole provider of CRM, DMS, sales lead, and inventory management data that did not heretofore exist, and which does not require special interfaces between vendor servers 130 and the network server(s) 110 in order to be implemented.

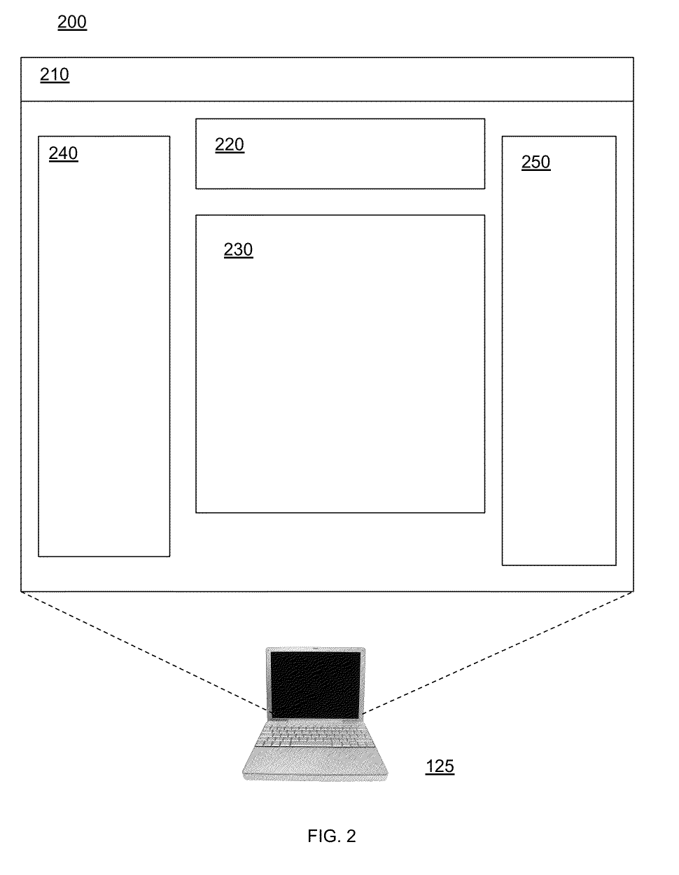

Turning now to FIG. 2, therein is depicted an exemplary employee computer 125 having a display, which presents a user-specific data template 200 as a display screen to an employee of a vendor, in manners that are well-known to those of ordinary skill in the art. The data template 200 may have separate virtual display areas 210-250 for presenting information and providing access to Gratis tool functions to an employee of a vendor. Certain portions of the data template 200 are the same no matter who the user is. Other information within the data template 200 though may be tailored to a specific user that is accessing the system, as described in more detail below. In various embodiments, the user-specific data template 200 is in a format that is used by web browsing software on the employee computer 125. In particular embodiments of the data template 200, a first display area 210 provides menus of functions, a second display area 220 provides vendor-specific identification information, a third display area 230 presents data in response to a selection of a menu function from the first display area 210 (such as profile or wall data), a fourth display area 240 may present third party advertising, and a fifth display area 250 may provide various widget functions that may be selected for use. The virtual display areas 210-250 have been illustrated and described for purposes of illustration only. It should be appreciated that the information displayed on the display screen 200 of the employee computer 125 may be provided in any useful format and is not in any way limited by the exemplary descriptions provided herein.

The first display area 210 may provide GRATIS TOOLS functions in the form of one or more selectable menu options that an employee may select using an input device (such as a mouse, keyboard or touchscreen) of the employee computer 125 in well-known manner. The available menu functions may be dependent on the type of user interacting with GRATIS TOOLS. For example, different menu options may be presented to employees of the vendor than to customers of the vendor. In general though, exemplary menu headings may include “Home,” “Profile,” “Logout,” “Vendor Locations,” “Inventory,” “Find People,” and “Admin.”

Selection of the “Home” menu option will direct the display of an initial homepage of the vendor presented by the vendor-centric ICC network. The homepage may have information that is tailored to the specific user viewing the homepage. The “Profile” menu option may be selected, after which various options relating to the user's wall are presented, including information that is to be displayed on the user's wall to other users. The “Logout” menu option may be selected to end current interactions with and navigate away from GRATIS TOOLS environment. The “Vendor Locations” menu option may be selected to present one or more physical locations of the vendor in the real world and to select one of those particular location to interact with. The “Inventory” menu option present thumbnail photographs and summary data of products available in the inventory of the vendor. One or more virtual pages of such inventory information may be presented in the third display area 230 in response to a selection of the “Inventory” menu option. The “Find People” menu option may allow the employee to locate other members of the vendor's community in the vendor-centric ICC network, based on the user's role and other user characteristics for members of the community. The “Admin” menu option, which may be made available to only those employees at a management level, allows the user to edit groups within the community, edit dealership information, edit inventory, create broadcast messages for distribution to the entire community or a subset thereof, create reports from usage statistics of the vendor-centric ICC, as well as internal CRM, DMS, Inventory Management and Sales databases of the vendor (as may be stored in vendor server(s) 120), and to select advertising and widget functions that are to be presented to community members. The recitation and order of such menu options have been provided herein for purposes of illustration only and it should be readily appreciated that the types of menu options, their location on the display screen 200 and the functions they represent may vary according to the needs of a vendor. Specific uses of the above functions will now be described with respect to various levels of employees of a given vendor within the network environment 100.

The second display area 220, as introduced above, may provide information determined by the vendor for identifying that vendor to an employee or other member of the vendor's ICC. Such vendor identification information may include a name and logo of the vendor, photographs, contact information, physical address of the vendor and the like, at the vendor's sole discretion. The second display area 220 thus confirms to a community member that they have accessed the correct network location for the vendor's ICC network presented by GRATIS TOOLS.

The third display area 230 may present data to an employee of the vendor in response to a selection of one or more selectable functions provided in the first display area 210, as described above. For example, the third display area 230 may present wall information specific to the employee when that employee selects a function to view their online profile. With the selection of successive functions, the third display area 230 is updated with corresponding information The third display area 230 may present any of the data described herein for use by the employee of the vendor while interacting with GRATIS TOOLS. Other uses for the third display area 230 will be readily apparent to one of ordinary skill in the art.

The fourth display area 240 may be used to present advertising data, including offers from the vendor and any third-party advertising as described herein. The advertising may be targeted to the user viewing such data. In the case of a sales employee for example, the employee may be presented with any new or current offers being made by the vendor to its existing and/or prospective customers. In this manner, the vendor's sales force have a ready reminder of offers that may be made to the customers of the vendor when dealing with them face to face.

The fifth display area 250 may be used to present widgets to the users of the vendor's ICC network. The widgets may be selectable software tools for use by the user while interacting with GRATIS TOOLS. The widgets to be presented may be selected by the vendor and be targeted based on the type and known characteristics of the user. For example, where the user is a sales person employed by the vendor, one widget to be presented in the display area 250 may be a financial loan tool for quickly calculating the terms of a loan for a customer to purchase a product of the vendor. The sales person may use this widget during a face to face transaction with a customer of the vendor. Other widgets, as described herein and as are widely known in the art, may also be provided.

Through interaction with GRATIS TOOLS, a vendor's management level employees can readily view communications between the customer and employees by viewing, dealership, employee and customer walls or by generating reports on customer communications. Every message posted on a given wall is stored by the network server(s) 110 for perpetuity. In this way, all communications and understandings with a customer may be readily verified.

Management level employees may also post content of interest for customers on their wall by broadcast messaging. Such broadcast messages may be targeted to customer's having certain characteristics, such as a prior purchase of a particular product. One example of a broadcast message is a dealership newsletter, which previously had been printed and mailed or emailed to the customer, but may now be readily prepared and transmitted to customers or potential customers of interest with greater ease via broadcast messaging. Broadcast messages may be permanently archived and searchable by community members. Management level employees can also broadcast messages directly to employees, such as for calling meetings, making appointments and other like functionality.

Management level employees may designate those advertising and widgets that are to be provided to different groups of members of the community. A widget is a software tool dedicated to a single specific function. Examples of widgets include a loan calculator for calculating the terms of a loan to purchase a product, a news widget for presenting the latest news headlines, a weather widget for receiving the latest weather information for a user's geographic location, and a stock widget for tracking the performance of one or more stocks. Provisioning of such widgets encourages users to use GRATIS TOOLS for more than just interactions with the vendor. By posting widgets and then monitoring customer usage of the same, a vendor can gain valuable insight into customer trends, characteristics and interests.

Finally, the maintenance of the vendor's wall will be critical to the vendor's marketing success. Accordingly, a Vendor Wall Management function is provided to management-level employees of a vendor. The wall needs be informative, inviting, have a purpose and most of all promote sales the development of additional revenue. Accordingly, the vendor may dictate the wall's appearance and the advertising presented thereon. The vendor may also control the rights and privileges of all other members of the community. For example, the vendor may restrict the customer's ability to communicate or provide information to other customers of the vendor. Such communications may be prohibited, or may be delayed pending review of the communication by vendor employees. A wide variety of rights and privileged may be established by the vendor to control both employee and customer interactions with GRATIS TOOLS.

In addition to the foregoing management employee functions, additional functions may be provided by GRATIS TOOLS to sales and service employees. For example, salesmen can post an acceptable photo on her profile wall and write a short bio for customers to read. They may view the walls of their customers and post messages thereto seamlessly. They may also generate broadcast message to targeted customers.

Service Department employees of a vendor can post messages for the customer about a specific service and gain acceptance to change or up-sell a service easily and quickly in a documented form. They can also post invoices and set appointments that are accessible at anytime the customer needs. They can also reference previous repairs done on a customer's car at anytime since such information will be posted on the wall of a customer using data stored in repair databases maintained by the vendor on the vendor servers 120. A customer may also pay for products provided or services rendered by the vendor online using their wall.

GRATIS TOOLS provides interfaces to all employees of a vendor for the following vendor functions: inventory management tools, DMS, CRM and sales lead tools. GRATIS TOOLS may interface with many other standard software used by the vendor in the past to accomplish these functions. These interfaces provide data concerning interactions with a customer, including, for example, sales or services performed regarding a customer's vehicle. Prior such software tools are mostly archaic, predominately text-based rather than graphics based, and are not designed for database management. GRATIS TOOLS, on the other hand, will accept and migrate data from these tools and in turn provide a cohesive graphical user interface for the same.

GRATIS TOOLS includes an aggressive CRM that will cross-reference, maintain and utilize databases of prospective and existing customers. The GRATIS-provided CRM is used by management level employees as well as sales personnel to better track and report the activities of potential customers, as well as follow the activities of existing customers through their product ownership period, such as service activity. These tools may include the following:

Agenda and history reports may be generated to provide a complete snapshot of prospective and existing customer activities. This report may be run periodically to provide lists of past, present and future customer prospects, customers with appointments and customers with automatic call back messages.

Interactive daily planners for salespeople, managers and service department employees, which allows these employees to follow client activity on a periodic basis.

A financing calculator allows salespeople to calculate financing for the customer with many financing levels and options in order to provide the customer with optimum financing options.

No call/no spam compliancy allows the dealership to assure compliance to these laws. This feature significantly reduces dealership vulnerability to recent privacy legislation. With this feature, the customer database is matched with the federally-mandated No Call list allowing dealership personnel to be aware of those customers who do not want to be contacted via phone or e-mail.

Patriot Act compliancy is assured by GRATIS TOOLS, which interfaces with Patriot Act mandated databases, giving vendors assurance that products are not sold to terrorists and no identity theft has occurred.

Finally, automatic callback messages and reminders appear on the daily agenda reports in order to assure customer contact callbacks are flagged for follow up. If a customer is not contacted based on these messages, the system carries this customer callback forward in order to keep track of the customer. Automatic or requested letters may be generated daily.

In addition to the foregoing CRM functions, GRATIS TOOLS may provide the following exemplary DMS functions to the various employees of a vendor:

GRATIS TOOLS may provide periodic data uploads from a vendor's DMS software systems, such as are provided by REYNOLDS, ADP or EDS, This interface provides a complete profile of sold or serviced customers. Customer Satisfaction Index (“CSI”) profiles can be, and are, installed as automatic functions. Long-term client retention letters and messages can be developed. This import may include email messages as well.

An Identification (ID) Scanning function assures that when drivers' licenses are scanned during a financial transaction at the physical location of the vendor, the data is automatically transferred into the vendor's CRM/DMS system for use by GRATIS TOOLS. This automates the customer data entry process, thereby reducing need for extra data entry employees.

An Electronic Signature Pad interface to GRATIS TOOLS enables the vendor to store an electronic signature of a customer where, for example, permission is given to check credit. This has traditionally been a legal vulnerability for automobile dealerships in particular since in many states, the dealership must have a valid customer signature within the past month in order to obtain a credit rating

An Automatic Lease Follow-up function provides a periodic listing of letters to those customers whose leases are coming due 120, 90, 60 or 30 days from the current date. These clients will also appear on reports for the benefit of a vendor's lease department.

A Direct Marketing interface enacts an upload of all the vendor's customer profiles from the DMS. This data is then cleaned, formatted and inserted into GRATIS TOOLS for use by the vendor. A customer archive is also generated and made available for future customized direct marketing. This marketing could take the form of e-mail, audio or synthesized voice messaging, and/or texting.

A Service Follow-Up tool enables reminders to be printed for mailing or electronic transmission to customers based on projected or actual usage of the product by a customer.

Finally, an OEM Direct Communication function allows bi-directional communication with manufacturers of a product sold by the vendor.

In addition to the foregoing DMS functions, GRATIS TOOLS may provide the following exemplary inventory and database management functions to the various employees of a vendor:

A complete Inventory Management Tool of new and used products in the vendor's inventory is provided. Since used cars, for example, depreciate continuously while an automobile dealer is paying interest on the cost of its acquisition, the quality and quantity of used cars in the showroom and proper management of those is extremely important to the wellbeing of a dealership. When, managed properly used car departments can be great source of profit for an auto dealership. The decision as to how long to maintain a used car, how much to pay for a trade and what is available in the area of influence has always plagued the dealers. GRATIS TOOLS will search the web in the designated region of the dealership and find a similar vehicle on the web sites of other local dealerships, or other similar sources. It then collects and returns price, date of entry, and other conditions of interest. Once a vehicle has entered the CRM database, GRATIS TOOLS will automatically alert the dealership of similar vehicles sold in the area and appropriate pricing along with how long such a vehicle has been on the floor of neighboring dealerships.

An Inventory Management Log matches a vendors new product inventory with third-party valuations (such as BLACK BOOK standards), thus providing the vendor a method of gauging the state of their inventory.

A Manager's Desk Log allows control of all customer contacts information for the vendor.

A Service Manager's Desk Log allows service manager to view and maintain customer interactions with the vendor's service department.

A Business Development Center (BDC) Manager's Desk Log allows the BDC manager to manage customer complete follow-up inquiries (after a service appointment or the like) based on OEM requirements.

Finally, an Internet Leads Management tool allows employees to view all communications and interactions with prospective clients.

In addition to the foregoing vendor functions, GRATIS TOOLS may also readily provide the following exemplary general reporting capabilities:

A Composite report runs periodically and reflects the activities of the entire sales force by employee name. This report presents the number of contacts a salesperson has and how they were initiated. Demonstration ratios, closing ratios and delivery ratios appear here as well.

A Salesman Effort report runs periodically and shows the number of customer contacts collectively and individually for the sales force, collective and individual sales closing ratios for salespeople, and additionally measures the performance of the Business Development Center in conducting OEM required customer follow-up. This report allows management to see what their customers are looking for when they contact the dealership and whether the dealership satisfied their need.

A Source Report runs periodically and allows the vendor to see what sources and efforts brought in customers, the products that generated interest, and the products ultimately purchased. This is a tool to gauge how well the vendor's advertising dollars are being spent. As an example, the ability of the system to import emails will allow the dealer to see the best source of Internet clients, in terms of both sales and gross profit.

A Zip Code Report is similar to the Source Report described immediately above except that the information is sorted by zip code. This report readily identifies which are the most valuable zip codes in the area in terms of customer generation. Under usual circumstances these zip codes tend to remain the same. The dealership then may use this information to guide the direction of prospective customer advertising.

A Lost Deal Report may be generated periodically to show the vendor what potential sales were lost, to whom and an identification of the losing salesperson.

In addition to the foregoing general reporting functions, GRATIS TOOLS may provide the following exemplary service reports to the various employees of a vendor:

A Repair Orders Report allows vendors to readily identify and subsequently contact customers who have been to service in the preceding relevant period for follow-up on service performed by the vendor and to gauge customer satisfaction.

A Not Been to Service Report lists existing customers who is have not returned to the service department and any known reasons for their discontinued patronage.

A Citrus Report lists customers who have been to dealership too many times in a given period with the same product, and a list of the services provided.

A Profitability Report identifies top customers and their demographic information.

A Management Penetration Report that shows who is the most valuable manager, who closes the most sales and which salesmen work best. This report is a tremendous tool for gauging the effectiveness of the sales management. GRATIS TOOLS also allows the vendor to customize this reporting based on any available variables or groups of variables.

Dash Board and Customized Reporting Capabilities allow the vendor to define any stored data for reporting on a periodic basis. The employee can produce and define reports of any kind that might be needed for the various databases maintained by the vendor. These custom reports, once defined and stored, may then be posted on the “wall” of that user for ready and automatic access when that employee logs into GRATIS TOOLS.

The majority of customer communication and follow-up will be automated by an Automated Customer Follow-up function. GRATIS TOOLS will generate communications according to the needs of the customer. These communications could be specific to a particular customer, such as service reminders. The specific reminders may then be posted on the wall of that specific customer.

A Finance and Insurance function may be provided to enable quick processing of financing or insurance documentation associated with product sales, such as in the automobile industry. This function will communicate with a vendor's CRM and DMS software and will enable the finance manager to complete a deal and import details into its DMS databases with ease. The tool will be also able to collect FICA reports on a client and complete required forms from the onset of a sale to product delivery.

The foregoing details various functionality provided to vendor employees in the network environment 100 via the network server(s) 111. Attention will now be given to those functions that are provided to customers of the vendor within the vendor-centric network environment.

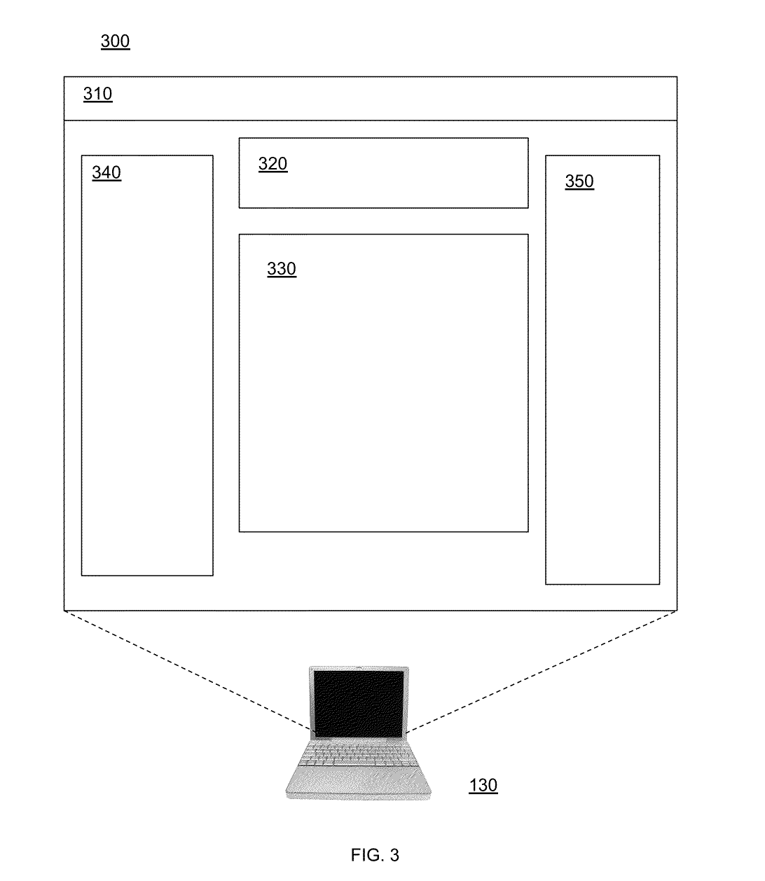

Turning now to FIG. 3, therein is depicted an exemplary customer computer 130 having a display, which presents a customer-specific data template 300 to a customer of a vendor, in manners that are well-known to those of ordinary skill in the art. The data template 300 may be presented as a display screen having separate virtual display areas 310-350 for presenting information and providing access to GRATIS TOOLS functions to the customer. In various embodiments, the customer-specific data template 300 is a data template in which customer-specific data from the vendor's databases are presented to the customer as a web page by web browsing software on the customer computer 130. In particular embodiments, a first display area 310 provides menus of functions, a second display area 320 provides vendor-specific identification information, a third display area 330 presents data in response to a selection of a menu function from the first display area 310 (such as profile or wall data), a fourth display area 340 may present third party advertising, and a fifth display area 350 may provide various widget functions that may be selected for use by a customer via customer computer 130. The virtual display areas 310-350 may be similar in function to their corresponding display areas 210-250 described above with respect to FIG. 2, and likewise have been described and depicted herein for purposes of illustration only. It should be appreciated that the information displayed on the display screen 300 of the customer computer 130 may be provided in any useful format and is not in any way limited by the exemplary descriptions provided herein.

All customers will be able to configure certain vendor-defined aspects of their profile or wall, which will be visible by the community and is presented to the customer, for example, in the third display area 330. The rights and privileges granted by a vendor to its customers will automatically control unwanted information from appearing and being exposed on any specific wall. The customer may otherwise populate their wall with photographs of purchased products, or a wish list of products desired by the customer. The customer can easily access their profile from any location and device having access to the Internet. They can also readily see details of their transactions with the vendor, including products purchased from the vendor, products serviced by the vendor, the employees of the vendor that were involved in those transactions and other relevant information. This transaction information is readily obtained from existing transaction databases that vendors largely have always maintained. The transaction database is one of many databases that a vendor may make available to GRATIS TOOLS for cross-referencing information, such that a detailed transaction history can be provided to customers via their walls.

The third display area 330 may also be used to send and receive messages with relevant employees of the vendor. For example, a new service appointment may need to be set, and that appointment may be arranged via GRATIS TOOLS by communications with service employees or by selecting a “Schedule an Appointment” function from the function menu in the first display area 310. A scheduled appointment will then appear on the customer's profile, which can be accessed at any time. Communications may be enabled only for employees with which the customer has previously interacted on the wall of the customer. GRATIS TOOLS functions may also allow a customer the option to authorize and approve an open transaction, such as a servicing or repair of the customer's car, via communications on the customer's wall, which may in turn be referenced by the vendor and customer at any time. Reminders of appointments or scheduled services may be automatically sent from the customer's wall to an external telephone number of e-mail address of the customer, as the customer may designate. Similarly, any changes or updates that have been made to a customer's wall by an employee or other community member can automatically be communicated to the external address designated by the customer.

The entire dealership inventory can be accessible from the wall. The customer may also use their own wall to store “wish lists” concerning products or services that they have an interest in acquiring or receiving more information about. In the case of automobile dealers, the customer can store makes and models of cars they own so that their vendor can communicate with them if they have offers concerning their vehicles. On each profile, a customer can upload pictures of themselves and/or their vehicles and generate a textual description of the same. Each customer has access to a list of their own vehicles and all the repairs done to that vehicle in chronological order. By allowing customers and employees to blog within the secure network of the vendor's ICC on such users' walls, the vendor will have a strong handle on the desires and level of satisfaction of community members.

Another available function provided by GRATIS TOOLS is to post receipts for purchases on the wall of the respective customer for that transaction. This cuts down on paper printing of such receipts, brings customers back to their wall more often and is a true service to the customer. Customers can access their receipts whenever they have access to the Internet.

Customers' walls allow vendors to communicate easily and seamlessly with their customer base directly. If they want the customer to receive a sales offer, they do not have to email that customer as was done in the past. Instead, they can just post it on the wall for all to see or post it exclusively on specific profiles of customers with desired characteristics. GRATIS TOOLS allows monitoring of their customers activities on the wall and may store such information in a tracking database that is accessible to the respective vendor. Hence, vendors that use GRATIS TOOLS can readily tell which advertisements, campaigns and user functions are receiving the most attention. GRATIS TOOLS will also provide critical tools that can simplify the sale process by, for example, presenting financing options and leasing options to customers via their wall.

Vendors may allow third-party vendors from other markets to post advertisements on the walls of community members, which is visible, for example, in the fourth display area 340. Such third-party advertisement placement presents a great opportunity to enable an additional revenue stream to vendors. Vendors may receive payments for such placement from third-party advertisers that wish to participate. Alternatively, or in addition thereto, the operator of GRATIS TOOLS may secure advertising from third-party advertisers and offer them to vendors for placement in their respective vendor-centric networks. In such embodiments, the revenue from such advertising may be shared between the vendors and the operator of GRATIS TOOLS. The revenue generated from this opportunity can easily offset the vendor's subscription costs to GRATIS TOOLS. The advertising placements on the fourth display area 340 may take any useful form, including all standard web formatted advertising as are well-known in the art and including Quick Response (QR) codes that may be scanned by community members viewing such advertisement. Ads presented to customers via GRATIS TOOLS may be rotated so as to present dynamic content to customers upon successive views of their walls.

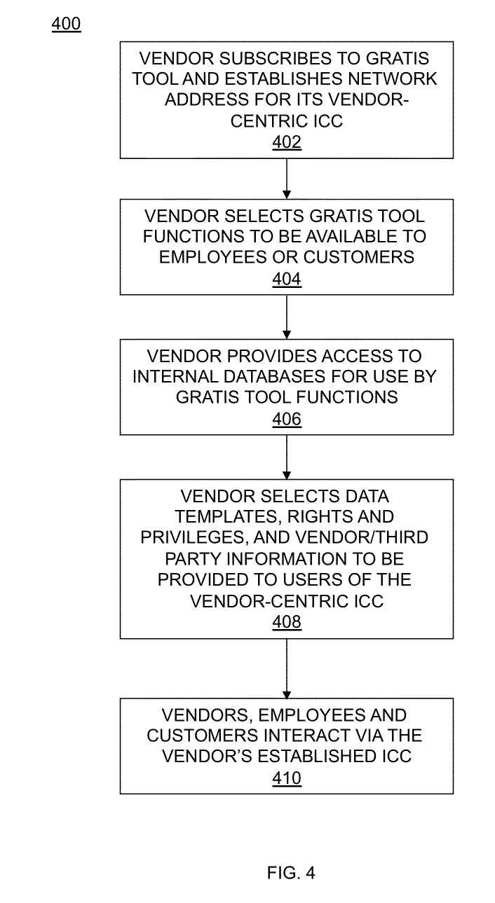

Turning now to FIG. 4, there is depicted an exemplary process 400 by which vendors may establish a vendor-centric ICC via GRATIS TOOLS that is accessible on the Internet. First at step 402, a vendor, via vendor server 120, navigates to GRATIS TOOLS on the Internet and subscribes to GRATIS TOOLS according to its terms and conditions. Upon such subscription, a network address, such as a Uniform Resource Locator (URL), is established on the Internet for the vendor's ICC network. The vendor's ICC may be operated as a cloud service maintained by the network server(s) 110 of the operator of GRATIS TOOLS. Separate network environments will be provided for each subscribing vendor.

Next, at step 404, the vendor selects which functions of GRATIS TOOLS will be made available to different groups of community members, such as employees, management level employees, existing customers and prospective customers. Each group may have access to differing ones of the functions described previously above, at the discretion of the vendor.

Next, at step 406, the vendor provides access to internal databases for use by Gratis tool functions. For example, the vendor's existing customer database may be interfaced over a secure Internet connection with the network server(s) 110 of GRATIS TOOLS. Data may be imported according to database type in manners that are well-known in the art. The customer database may then be used to establish initial profiles for the vendor's existing customers. Likewise, the vendor's inventory, CRM, DMS sales lead and other databases may also be interfaced and cross-referenced by GRATIS TOOLS to accomplish the other functions described herein. New data generated by operation of the vendor ICC network may be stored in the cloud services offered by GRATIS TOOLS or at the vendor server 120 in accordance with the vendor's subscription preferences.

Next at step 408, the vendor selects those user-specific data templates that will be used to present the information and functions described hereinabove to the members of the vendor's ICC. Such data templates may correspond to the views of FIGS. 2 and 3, as described above. Alternatively, or in addition thereto, the vendor may be able to define custom data templates that will be presented to their community members on their computer displays. The vendor may also assign each group of community members, or even individual community members, differing rights and privileges for the use the functions provided by GRATIS TOOLS within the network. For example, certain groups or individuals may be granted access to broadcast a message community-wide, while other members of the community may not have access to such functions, at the sole discretion of the vendor. Finally, the vendor may select the internal and third party advertising as well as manufacturing or other third party information that are to be presented to the community members. The vendor may select the schema for presenting such advertising and information, such as by rotation of ads placed on customer walls or by targeting ads and information to customers with particular demographics, geographic location or other characteristics. The selections made in step 408 are stored by the network server(s) 110 from which the vendor-centric ICC is generated and maintained. Such settings may be updated at any time according to the needs of the vendor as their network evolves over time.

Upon completing subscription requirements, interfacing the necessary databases and establishing the rules of the ICC network in the preceding steps, the vender's ICC network is ready to go live on the Internet. Accordingly, at step 410, community members are given user name and login credentials via their existing external e-mail or cellphone number and invited to join the vendor's ICC network. Upon registration of community members, the vendors, employees and customers commence interacting via the vendor's established ICC.

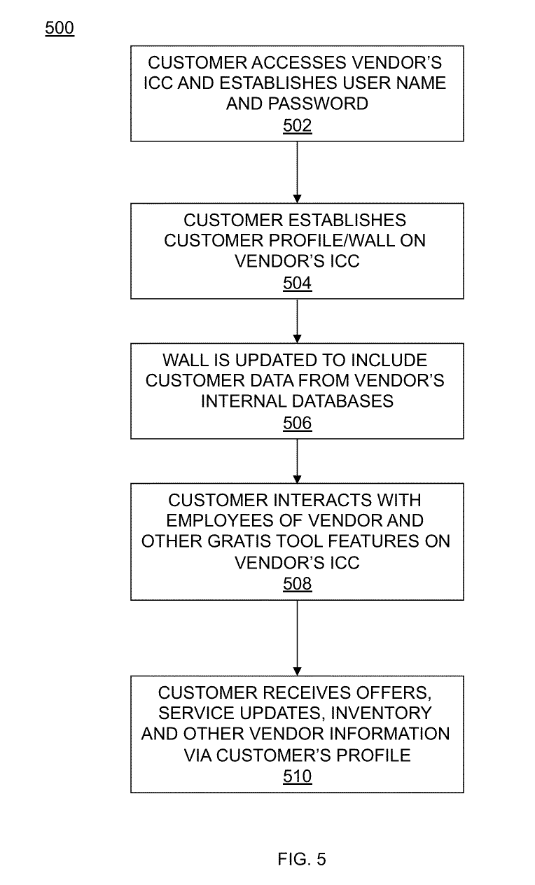

Turning now to FIG. 5, therein is depicted an exemplary process 500 performed by a customer, using customer computer 130 for initiating their membership and establishing their profile or wall within the vendor-centric ICC network that is established and maintained by GRATIS TOOLS.

At step 502, the customer computer 120 navigates to the network address established for a vendor's ICC and enters a suitable user name and password credentials, upon validation of which, access is granted to the customer's wall via a user-specific display template 300 presented on the customer computer 120 in the form of a web page.

Next, at step 504, the customer enters any information, including text, photographs or the like, that are to be added to the customer's profile. The customer may also select any other settings that are offered by the vendor. The posted photos and wishlist settings of the customer's wall may be changed by the customer at any time after they are established. Information from the wall may be shared with other members of the vendor's ICC at the discretion of the vendor.

Next, at step 506, GRATIS TOOLS populates the customer's wall with information from the vendor's databases, such as contact information, transaction history, scheduled appointments and other information heretofore described. Those employees with which the customer has previously interacted will be listed on the customer wall along with any communications options that are available for contacting such employees. Inventory information, sales offers, third-party advertising and third-party information such as manufacturer's data on products, widgets and available GRATIS TOOLS functions are then populated in the appropriate display areas 310-350 as previously described.

Next, at step 508, the customer may interact with employees of vendor and other GRATIS TOOLS functions as previously described via their established wall.

Finally, at step 510, customer receives offers, service updates, inventory and other vendor information via customer's profile as time goes on. Such information and data are dynamically presented over the time to avoid stagnation of the customer's wall. This serves to incentivize the customer to return to the wall periodically and keep the customer's wall interesting and useful to the customer.

Other members of the community may establish their profiles or walls in a manner similar to that described for the customer above with respect to FIG. 5.

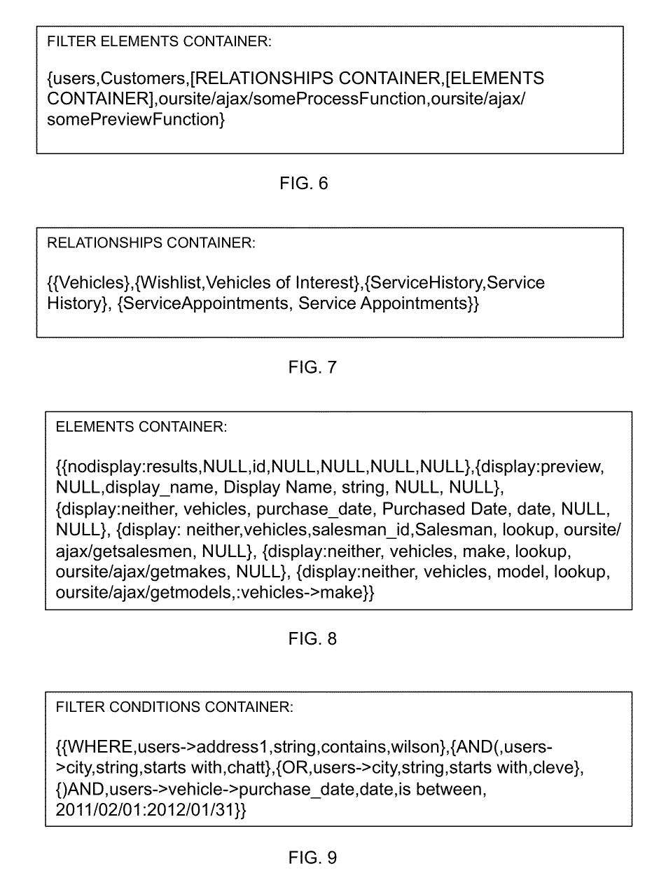

Turning now to FIGS. 6-9, therein are depicted exemplary hypertext markup language (HTML) format for containers that may be used by GRATIS TOOLS for generating the user-specific data templates described above, which in turn, are presented to the displays of the computers as profiles or walls of community members who are interacting with a vendor-centric ICC. By use of well-known HTML or code editing software, the data templates 200 and 300 presented by GRATIS TOOLS may be readily generated. Such web pages will include all of the appropriate document tags to provide the portions of the display such as background and the like that may be static, as is well known in the art. Containers may be used for generating those portions of the data templates 200 and 300 that contain dynamic web content. This enables the information display in certain of the display areas 210-250 and 310-350 to change in response to a selection of a function presented on the wall. Containers are used as envelope for that dynamic web content. Containers are reusable for many types of web content. They can contain a title and dynamically inserted values of the contained web content. Containers also act as objects in the web environment and thus can have values that may be readily imported and exported to particular databases as necessary to accomplish the functions described herein. Containers can be assigned not only to dynamic web content but also to widgets and third-party information as described previously.

FIG. 6 depicts an exemplary format of a “Filter Elements” which cooperates with a “Filter Conditions” container (described below with respect to FIG. 9) to produce data to be displayed in a display area in response to a function selected by a user interacting with their wall. The Filter Elements container builds an interface that lets the members select information to be queried from a stored database. In turn, a Filter Conditions container will be used to produce a structured query language (SQL) query based on the user selection, after which the SQL query is submitted to relevant stored databases, and relevant data is returned and displayed in response to the user query. The “Filter Elements” container may include the following variables as shown in FIG. 6:

primary_table_name—an identification of a primary table of data to be generated

primary_table_display_value—how this table name should be displayed

Relationships Container—a container for tables related to the primary table

Elements Container—a container of the columns for the primary table

results_callback_URL—the URL for the call to process the query

preview_callback_url—the URL for the call to preview and display the results

Exemplary values of these variables appear in order in FIG. 6. Other formats, values, names and data structures may be equivalently used as will be readily apparent to one of ordinary skill in the art. Other containers referenced above will be described in more detail with respect to the remaining Figures.

Turning to FIG. 7, therein is depicted an exemplary format of a Relationships Container as referenced above. The Relationships Container may have the following variables as depicted in FIG. 7:

relationship_name—the relationship name (which may serve to identify the relevant database to query)

relationship_display_values—the values in the relevant database that should be displayed, for example, where the query relates to the customer's purchased vehicles, the customers wishlist of products of interest, service history service appointments may be returned.

Turning now to FIG. 8, therein is depicted an exemplary format of an Elements Container as referenced above. The Elements Container may have the following exemplary variables as displayed in FIG. 8:

element_scope—display/nodisplay:results, preview, both, neither

relationship_name—the relationship name from relationships container

element_name—the columnName from the table

element_name_display_value—how the name should be displayed

column_type—string, numeric, date, time, flag, enum, lookup, multiselect

type_callback_choice—a key/value paired list or a comma-separated list of display values

type_params_values—a comma-separated list of returned values.

Turning now to FIG. 9, therein is depicted an exemplary “Filter Conditions” container as referenced above. The Filter Conditions container have the following information:

conjunction_identifier—AND, OR or other logical functions

column_identifier—Table, RelationshipName, columnName values from above containers

column_type—string, number, date, time—allows formatting of appropriate SQL query based on field type

condition_identifier—selected from available conditions presented to a user

filter_value—selected or entered from available options presented to a user

A SQL query generated according to the variables depicted in FIG. 9 would result in the following SQL query and the provision of conforming data from the relevant database: users having geographic location information including the words Wilson (i.e. those residing on Wilson St.) and further starting with the value “chatt” or “cleve,” and who purchased a vehicle between Feb. 1, 2011 and Jan. 31, 2012.

This allows for functionality to be built in the following way:

The Elements Container gets sorted on relationship_name and element_name, which are then used to construct the selection list for each table to be displayed. The relationship_name is used to build the selection list for the each table. A blank relationship_name represents the primary table and all others represent the other related tables. Depending on which table it is, either the primary_table_display_name or the relationship_display_name is found by looking up relationship_name in the Relationships Container used as the list heading. For each element, the element_scope is split at the colon (:) into two values, show_mode and select_where. When show_mode is ‘display’, it is added to the list to be available for the user to select as a filter item. When select_where is ‘results’ or ‘both’ it is added to the results_list of items to be part of the select list of the resulting query for the process_callback_url. When select_where is ‘preview’ or ‘both’ it is added to the preview_list of items to be part of the select list of the resulting query for the preview_callback_url. So, based on the element_scope, all items that the user is able to select as filter items, all items to be included in a preview of filter application allowing the user to gauge if the filter is correct, and all items to be included in the actual results to be passed on the process function may be readily provided. Also, this allows to specify an item that is part of the results select list only by specifying ‘nodisplay:results’ as the element_scope which lets an item like ‘id’ to be selected as a column of the table, but not require it to be an item that can be filtered. When an item from one of the table lists is chosen, the column_type is used to determine the list of conditions to present. When the column_type is ‘flag’, ‘enum’, ‘lookup’ or ‘multiselect’, the type_callback_choice and type_params_values are used to build the selection lists for these items. For a column_type of ‘lookup’, the type_params_values can be used to specify a dependency on another lookup.

The business opportunity presented by GRATIS TOOLS is most directly applicable to the interests of automobile dealers in particular. By subscribing to GRATIS TOOLS, dealers may improve upon the ratio of contacts to closed sales, communicate properly and in a timely manner with their customers and strive to become the “dealer of choice” to those customers. A customer earned is not only valuable to the dealer for the sale of the vehicle, but their value increases in time with the service of that vehicle as well. Also, customers are becoming more and more choosy with whom they will communicate. There are more and more “social” sites for people who have a common interest and that in the next ten years is projected to become the primary mode of social communication. Also, dealers are very much in need of gaining information about their constituents. A “trusted” network will readily yield the needed ability to sustain effective customer communications. So, the dealer will truly get to know the customer, the customer will get the products and services they desire and both will communicate with ease. By using the wall in a successful manner, subscribing dealers will effortlessly improve sales of their own products and services, and gain additional revenue from the advertising of third-parties on their wall.

Another great advantage of the wall is its ability to store content while simultaneously promoting a vendor's presence on the World Wide Web. This content may provide relevant information for the customer on product safety, product use and other pertinent information. As this information is accumulated on the wall, the wall's web site also moves higher and higher in web search engine results of third parties such as BING and GOOGLE. The search engine crawlers of today are highly sensitive to words packed together such that the site is elevated in the search results. Thus, the vendor's active maintenance and timely update of wall information can effortlessly attract more traffic and more prospective customers to the vendor.

Although various methodologies have been particularly described in the foregoing disclosure, it is to be understood that such descriptions have been provided for purposes of illustration only, and that other variations both in form and in detail could be made thereupon by those of ordinary skill in the art without departing from the spirit and scope of the present invention, which is defined first and foremost by the appended claims.

What is claimed is:

1. A method, performed exclusively over a computer network by at least one special purpose computer of a vendor, the vendor having a number of employees, the method comprising:
establishing a data communication interface having a network address on the computer network for the at least one special purpose computer of the vendor, the data communication interface allowing communication devices of a plurality of customers of the vendor to transmit data to and receive data from the at least one special purpose computer of the vendor;
establishing a data connection between a transaction database of the vendor and the at least one special purpose computer of the vendor, for accessing stored transaction data of purchase transactions between the vendor and the plurality of customers, the stored transaction data including an indication of employees involved with each transaction between the vendor and the plurality of customers;
establishing a data template for presenting data from the at least one special purpose computer of the vendor on displays of the communication devices of the plurality of customers;
receiving at the data communication interface an electronic request from a communication device of a customer to access the at least one special purpose computer of the vendor, the electronic request including an identification of the customer;
in response to the electronic request:
identifying from the transaction database, existing purchase transactions between the customer and the vendor, including those employees of the vendor involved with the existing purchase transactions; and
transmitting over the computer network a customer-specific data template for display on the communications device of the customer, the customer-specific data template including selectable options for communicating with only those employees of the vendor involved with the existing purchase transactions of the customer.

2. The method of claim 1, wherein the vendor comprises an automobile dealership and the existing purchase transactions include purchases of products and services from the automobile dealership by the plurality of customers.

3. The method of claim 1, wherein the computer network comprises an Internet, the network address comprises a website, the data template comprises a web page, and the communication device comprises at least one of: a computer, a personal digital assistant, a mobile telephone and a smartphone.

4. The method of claim 1, wherein the selectable options include at least one of: an electronic mail message, a text message, a voice message and an audio-visual message.

5. The method of claim 1, further comprising:
providing a listing of the existing purchase transactions between the customer and the vendor in the customer-specific data template.

6. The method of claim 5, wherein the listing includes an open purchase transaction between the customer and the vendor, the method further comprising:
providing in the customer-specific data template an option to at least one of: (i) approve a service recommended by an employee for the open purchase transaction, and (ii) pay for the service online.

7. The method of claim 1 wherein the customer-specific data template includes at least one of: (i) a customer-specific offer determined by the vendor based on existing purchase transactions of the customer, and (ii) vendor content that is presented publicly to all customers.

8. The method of claim 1, the special purpose computer of the vendor further comprising: a tracking database for storing tracking data of interactions with the customer device over the data network interface.

9. The method of claim 1, further comprising:
receiving, from the communication device of the customer via the data network interface, customer profile information including at least one of: a wishlist request for a product or service of the vendor, a photograph of a product purchased from the vendor; and a text description of a product or service purchased from the vendor; and
wherein the customer profile information is stored by the special purpose computer of the vendor and is included in other data templates of other customers only as designated by programmed sharing options selected exclusively by the vendor.

10. The method of claim 1, further comprising:
establishing a data connection between the at least one special purpose computer of the vendor and an advertising database comprising a plurality of advertisements from third-party advertisers, each advertisement for offering at least one of a product and a service, each advertisement associated with a specific geographic location; and
the customer-specific data template includes at least one advertisement of a third party advertiser selected from the plurality of advertisements based on a geographic location of the customer and the existing purchase transactions between the customer and the vendor.

11. The method of claim 1, further comprising:
establishing a data connection over the computer network between the at least one special purpose computer of the vendor and a manufacturer database of a manufacturer, the manufacturer database comprising proprietary information on products of the manufacturer and sold by the vendor; and
the customer-specific data template includes information selected from the manufacturer database based on any existing purchase transactions between the customer and the vendor including a product of the manufacturer.

12. A method, performed exclusively over a computer network by at least one special purpose computer of a vendor, the vendor having a number of employees, the method comprising:
establishing a data communication interface having a network address on the computer network for the at least one special purpose computer of the vendor, the data communication interface allowing communication devices of a plurality of customers of the vendor to transmit data to and receive data from the at least one special purpose computer of the vendor;
establishing a data connection between a transaction database of the vendor and the at least one special purpose computer of the vendor, for accessing stored transaction data of purchase transactions between the vendor and the plurality of customers, the stored transaction data including an indication of employees involved with each transaction between the vendor and the plurality of customers;
establishing a data connection between the at least one special purpose computer of the vendor and an advertising database comprising a plurality of advertisements from third-party advertisers, each advertisement for offering at least one of a product and a service, each advertisement associated with a specific geographic location;
establishing a data template for presenting data from the at least one special purpose computer of the vendor on displays of the communication devices of the plurality of customers;
receiving at the data communication interface an electronic request from a communication device of a customer to access the at least one special purpose computer of the vendor, the electronic request including an identification of the customer;
in response to the electronic request:
identifying from the transaction database, existing purchase transactions between the customer and the vendor, including those employees of the vendor involved with the existing purchase transactions; and
transmitting over the computer network a customer-specific data template for display on the communications device of the customer, the customer-specific data template including an advertisement of a third party advertiser from the plurality of advertisements, the advertisement selected based on a geographic location of the customer and the existing purchase transactions between the customer and the vendor.

13. The method of claim 12, wherein the customer-specific data template further includes selectable options for communicating with only those employees of the vendor involved with the existing purchase transactions of the customer.

14. The method of claim 12, further comprising:
establishing a data connection over the computer network between the at least one special purpose computer of the vendor and a manufacturer database of a manufacturer, the manufacturer database comprising proprietary information on products of the manufacturer and sold by the vendor; and
the customer-specific data template includes information selected from the manufacturer database based on any existing purchase transactions between the customer and the vendor including a product of the manufacturer.

15. The method of claim 12, wherein the vendor comprises an automobile dealership and the existing purchase transactions include purchases of products and services from the automobile dealership by the plurality of customers.

16. A method, performed exclusively over a computer network by at least one special purpose computer of a vendor, the vendor having a number of employees, the method comprising:
establishing a data communication interface having a network address on the computer network for the at least one special purpose computer of the vendor, the data communication interface allowing communication devices of a plurality of customers of the vendor to transmit data to and receive data from the at least one special purpose computer of the vendor;
establishing a data connection between a transaction database of the vendor and the at least one special purpose computer of the vendor, for accessing stored transaction data of purchase transactions between the vendor and the plurality of customers, the stored transaction data including an indication of employees involved with each transaction between the vendor and the plurality of customers;
establishing a data template for presenting data from the at least one special purpose computer of the vendor on displays of the communication devices of the plurality of customers;
receiving at the data communication interface an electronic request from a communication device of a customer to access the at least one special purpose computer of the vendor, the electronic request including an identification of the customer;
in response to the electronic request:
identifying from the transaction database, existing purchase transactions between the customer and the vendor, including those employees of the vendor involved with the existing purchase transactions; and
transmitting over the computer network a customer-specific data template for display on the communications device of the customer, the customer-specific data template including a customer-specific profile page having information about the customer as determined by the customer and other information determined exclusively by the vendor.

17. The method of claim 16, wherein the customer-specific data template further includes selectable options for communicating with only those employees of the vendor involved with the existing purchase transactions of the customer.

18. The method of claim 16, further comprising:
establishing a data connection between the at least one special purpose computer of the vendor and an advertising database comprising a plurality of advertisements from third-party advertisers, each advertisement for offering at least one of a product and a service, each advertisement associated with a specific geographic location; and
the customer-specific data template includes at least one advertisement of a third party advertiser selected from the plurality of advertisements based on a geographic location of the customer and the existing purchase transactions between the customer and the vendor.

19. The method of claim 16, further comprising:
establishing a data connection over the computer network between the at least one special purpose computer of the vendor and a manufacturer database of a manufacturer, the manufacturer database comprising proprietary information on products of the manufacturer and sold by the vendor; and
retrieving information selected from the manufacturer database based on any existing purchase transactions between the customer and the vendor that involve a product of the manufacturer.

20. The method of claim 16, wherein the vendor comprises an automobile dealership and the existing purchase transactions include purchases of products and services from the automobile dealership by the plurality of customers.
